(19) United States
(12) Patent Application Publication
(10) Pub. No.: US 2013/0154571 A1
(43) Pub. Date: Jun. 20, 2013

(54) POWER CONTROL SYSTEM AND METHOD

(71) Applicants: KUEI-CHIH HOU, New Taipei (TW); YUEH-NU HSIEH, New Taipei (TW)

(72) Inventors: KUEI-CHIH HOU, New Taipei (TW); YUEH-NU HSIEH, New Taipei (TW)

(21) Appl. No.: 13/676,208

(22) Filed: Nov. 14, 2012

(30) Foreign Application Priority Data
Dec. 16, 2011 (TW) 100146960

(51) Int. Cl. H02J 7/00

(52) U.S. Cl. CPC H02J 7/0063; H02J 7/007
USPC 320/134; 320/136

(57) ABSTRACT

A power control system includes a power control unit, a processing unit, and a power storage unit. The power storage unit supplies power to an electronic device when the electronic device experiences a sudden power failure from an external power source. The power control unit obtains a discharge voltage, a discharge current value and a discharge temperature of the power storage unit. The processing unit determines whether a protection voltage of the power storage unit should be changed or not according to the discharge temperature and the discharge current value. The power control system controls operation of the power storage unit according to a comparison between the discharge voltage and the protection voltage. The disclosure further provides a power control method.

### BACKGROUND

1. Technical Field

The present disclosure relates to a power control system and a power control method, and particularly to a power control system and a power control method for controlling power to an electronic device.

2. Description of Related Art

When a server experiences a sudden power failure, a backup power source, usually a battery, will replace the failed power supply or source. However, ambient temperatures affect the initial voltage outputted by the battery. For low temperatures (for example, a temperature of 10 degrees Celsius), the initial voltage may drop lower than an under voltage protection (UVP) threshold of the battery, and thus the battery may stop discharging for protection against damage. Accordingly, the server will shut down thereby resulting in data loss so that the stability of the server will be affected.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power system of the present disclosure.

FIG. 2 is a voltage-time diagram of a power storage unit of the present disclosure discharging at a high charge rate at a low temperature.

FIG. 3 is a flowchart of an embodiment of a power control method of the present disclosure.

### DETAILED DESCRIPTION

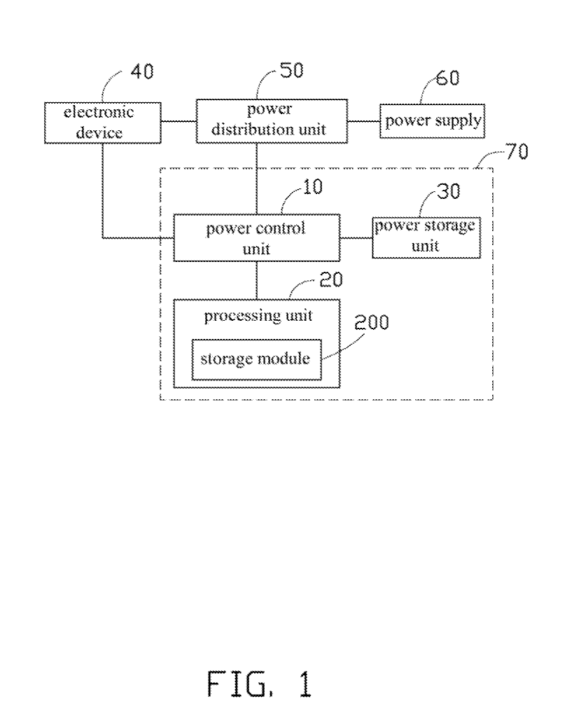

Referring to FIG. 1, an embodiment of a power system is shown. The power system includes an electronic device 40, a power distribution unit (PDU) 50, a power supply 60, and a power control system 70. The power control system 70 is configured for controlling power of the electronic device 40 and includes a power control unit 10, a processing unit 20, and a power storage unit 30. In the embodiment, the power supply 60 is an external power source for the electronic device 40 and provides an alternating current (AC) power. The PDU 50 converts the AC power of the power supply 60 to a direct current (DC) power for providing to the electronic device 40. In the embodiment, the electronic device 40 is a server, the power storage unit 30 is a battery, and the power control unit 10 is a battery backup unit (BBU).

The power control unit 10 receives the DC power converted by the PDU 50 to charge the power storage unit 30. The power control unit 10 controls the power storage unit 30 to discharge to supply power to the electronic device 40, when the power supply 60 stops providing the AC power.

The processing unit 20 includes a storage module 200, and obtains a discharge voltage, a discharge current value and a discharge temperature of the power storage unit 30 through the power control unit 10 when the power storage unit 30 is discharging.

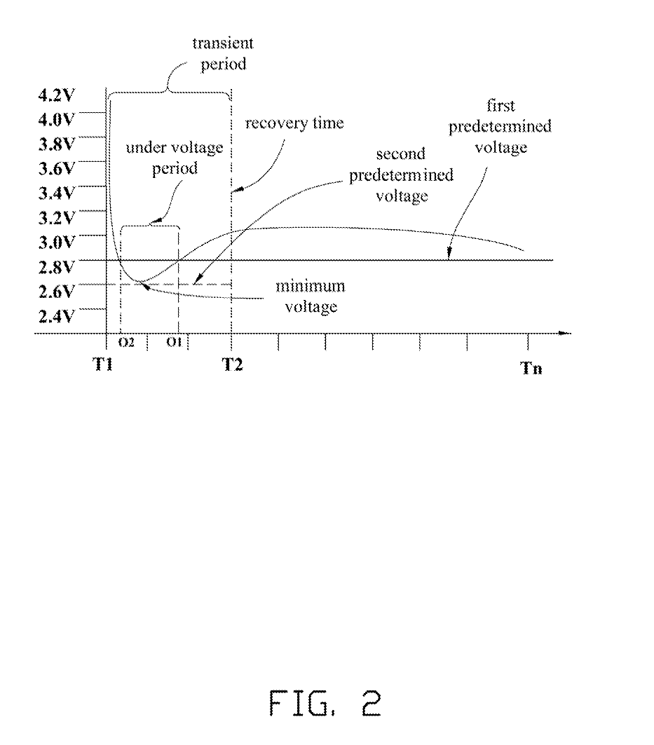

In the embodiment, the electronic device 40 may operate at a low temperature. However, the low temperature will influence output voltage of the power storage unit 30, and the output voltage of the power storage unit 30 will vary widely during the beginning of the discharge. As shown in FIG. 2, the discharge voltage of the power storage unit 30 may decrease to a minimum voltage and then increases to a stable voltage when the power storage unit 30 starts to discharge at a high charge rate at a low temperature. The power storage unit 30 starts to discharge at a first time T1 and the discharge voltage reaches the stable voltage from the minimum voltage at a second time T2 (a recovery time in FIG. 2). A time interval between the first time T1 and the second time T2 is a transient period of the power storage unit 30. In addition, an under voltage period is a time period during which the discharge voltage of the power storage unit 30 is lower than a first predetermined voltage (i.e. a time interval between two time points O1 and O2 in FIG. 1). In the embodiment, the first predetermined voltage is set as a protection voltage of the power storage unit 30 according to manufacturing specifications of the power storage unit 30 and the electronic device 40. The power storage unit 30 stops discharging when the discharge voltage of the power storage unit 30 is lower than the protection voltage; this is to protect against damaging the power storage unit 30.

If the power storage unit 30 is utilized as a backup power source of the electronic device 40, operating parameters of the power storage unit 30 can be set first. For example, the protection voltage of the power storage unit 30 is set first to be equal to the first predetermined voltage, i.e. an under voltage protection (UVP) threshold in the embodiment. In addition, the operating parameters further include a predetermined temperature, a plurality of predetermined current values, and a plurality of second predetermined voltages.

If the power storage unit 30 is discharging at a high temperature, the discharge process of the power storage unit 30 does not include the transient period. In other words, the output voltage of the power storage unit 30 will decreases to the stable voltage at a high temperature rather than decreasing to the minimum voltage and then increasing to the stable voltage. However, the electronic device 40 may operate at a low temperature, such as 10° C. Therefore, the predetermined temperature should be determined to differentiate whether the discharge process includes the transient period at the discharge temperature or not. In the embodiment, normal operating temperatures at which the discharge process of the power storage unit 30 does not include the transient period is measured first. The minimum temperature of the normal operating temperatures is set as the predetermined temperature stored in the storage module 200. Thus, the discharge process of the power storage unit 30 includes the transient period when the discharge temperature of the power storage unit 30 is lower than the predetermined temperature.

If the power storage unit 30 is discharging at a low rate at the temperature below the predetermined temperature, the discharge process of the power storage unit 30 does not include the under voltage period. In other words, the minimum voltage of the power storage unit 30 will not be lower than the first predetermined voltage when the rate is low and the temperature is lower than the predetermined temperature. However, the electronic device 40 may discharge at a high rate. Therefore, the predetermined current value should be determined to differentiate whether the discharge process includes the under voltage period or not. In the embodiment, normal operating current values in which the discharge process of the power storage unit 30 does not include the under voltage period at the discharge temperature is measured first. The maximum current value of the normal operating current values is set as a particular current value corresponding to the discharge temperature. Therefore, the discharge process of the power storage unit 30 includes the under voltage period at the discharge temperature when the discharge current value is larger than the particular current value. Moreover, when the discharge process of the power storage unit 30 includes the transient period, the discharge temperature can be any temperature lower than the predetermined temperature. Thus, the storage module 200 can store the plurality of predetermined current values, each of the predetermined current values corresponds to a temperature value. Accordingly, the particular current value is one of the predetermined current values corresponding to the discharge temperature.

Furthermore, a minimum voltage of the power storage unit 30 can be measured when the power storage unit 30 discharges during the under voltage period. In the embodiment, the minimum voltage is set as a particular voltage corresponding to a particular parameter group of the discharge temperature and the discharge current value. When the discharge process of the power storage unit 30 includes the under voltage period, the discharge temperature can be any temperature lower than the predetermined temperature and the discharge current value can be any current value larger than a corresponding predetermined current value. Thus, the storage module 200 stores the plurality of second predetermined voltages, each of the second predetermined voltages corresponds to a parameter group of a temperature value and a current value. Accordingly, the particular voltage is one of the second predetermined voltages corresponding to the particular parameter group of the discharge temperature and the discharge current value.

The processing unit 20 determines whether the power storage unit 30 is discharging or not. When the power storage unit 30 is discharging, the processing unit 20 obtains the discharge temperature of the power storage unit 30 through the power control unit 10. Then, the processing unit 20 determines whether the discharge temperature is lower than the predetermined temperature stored in the storage module 200 or not. When the discharge temperature is equal to or greater than the predetermined temperature, the output voltage will decrease to the stable voltage. In other words, the discharge process of the power storage unit 30 does not include the transient period and the under voltage period. At this time, the power control unit 10 checks whether the protection voltage of the power storage unit 30 is equal to the first predetermined voltage. If the protection voltage is not equal to the first predetermined voltage, the protection voltage is reset to be equal to the first predetermined voltage according to manufacturing specifications of the power storage unit 30 and the electronic device 40.

When the discharge temperature of the power storage unit 30 is lower than the predetermined temperature, the output voltage will decrease to the minimum voltage and then increase to the stable voltage. Thus, the discharge process of the power storage unit 30 includes the transient period. At this time, the processing unit 20 obtains the discharge current value of the power storage unit 30 through the power control unit 10 and a particular current value corresponding to the discharge temperature from the storage module 200. The processing unit 20 determines whether the discharge current value is larger than the particular current value. When the discharge current value is larger than the particular current value, the output voltage will decrease to be lower than the first predetermined voltage. Therefore, the discharge process of the power storage unit 30 includes the under voltage period. Thus, the processing unit 20 obtains a particular voltage corresponding to the particular parameter group of the discharge temperature and the discharge current value, and transmits a signal indicating the particular voltage to the power control unit 10. In the embodiment, the signal is received by the power control unit 10 during a time interval from the first time T1 to the beginning time O1 of the under voltage period. The power control unit 10 sets the protection voltage to be equal to the particular voltage. In other words, the protection voltage is decreased to be equal to the particular voltage when the discharge temperature is lower than the predetermined temperature and the discharge current value is larger than the particular current value. Accordingly, a situation where the power control unit 10 stops the power storage unit 30 from discharging when the power storage unit 30 is discharging during the transient period can be prevented.

In the embodiment, the processing unit 20 obtains the discharge voltage of the power storage unit 30 through the power control unit 10. When the discharge voltage is lower than the particular voltage, the processing unit 20 transmits a control signal to the power control unit 10 so that the power control unit 10 stops the power storage unit 30 discharging; this is to protect against damaging the power storage unit 30. For example, the discharge voltage will be lower than the particular voltage when the power storage unit 30 is short circuited. Therefore, the power storage unit 30 will stop discharging when the power storage unit 30 is short circuited.

In the embodiment, the power control unit 10 sets the protection voltage to be equal to the first predetermined voltage again according to manufacturing specifications of the power storage unit 30 and the electronic device 40, after the transient period of the power storage unit 30 ends. In other embodiments, the protection voltage is reset after the under voltage period of the power storage unit 30 ends.

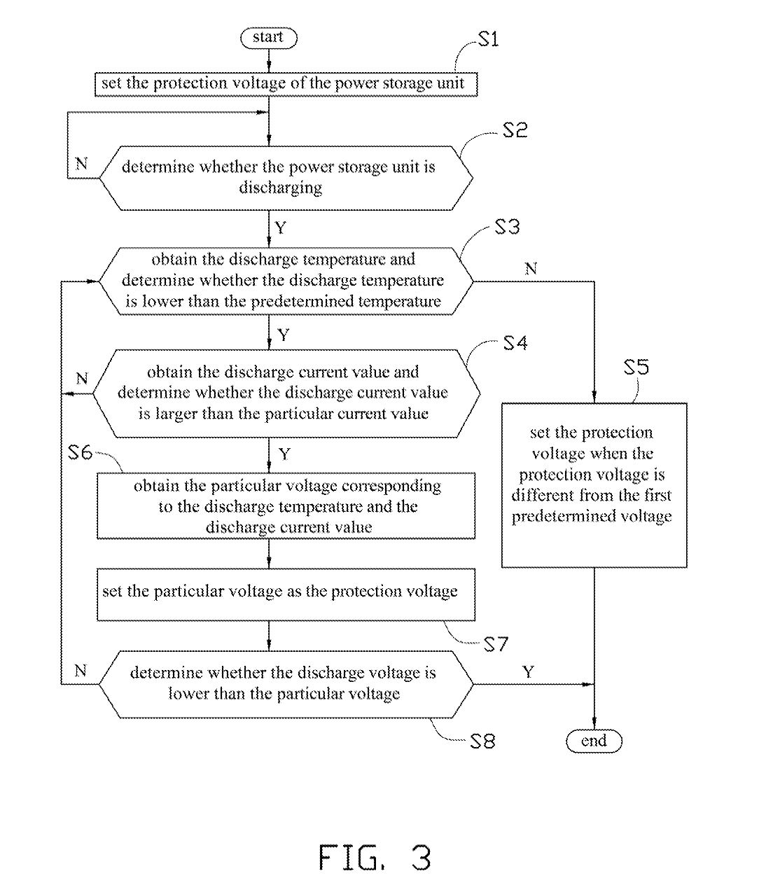

As shown in FIG. 3, an embodiment of the power control method is as follows:

In step S1, the protection voltage of the power storage unit 30 is pre-set to be equal to the first predetermined voltage according to manufacturing specifications of the power storage unit 30 and the electronic device 40.

In step S2, the processing unit 20 determines whether the power storage unit 30 is discharging or not. If the power storage unit 30 is not discharging, step S2 is repeated. If the power storage unit is discharging, the procedure goes to step S3.

In step S3, the processing unit 20 obtains the discharge temperature of the power storage unit 30 through the power control unit 10, and the predetermined temperature from the storage module 200, and determines whether the discharge temperature is lower than the predetermined temperature. When the discharge temperature is greater than or equal to the predetermined temperature, the discharge process of the power storage unit 30 do not include the transient period and the procedure goes to step S5. When the discharge temperature is lower than the predetermined temperature, the discharge process of the power storage unit 30 includes the transient period and the procedure goes to step S4.

In step S4, the processing unit 20 obtains the discharge current value of the power storage unit 30 through the power control unit 10 and the particular current value corresponding to the discharge temperature from the predetermined current values stored in the storage module 200. The processing unit 20 determines whether the discharge current value is larger than the particular current value. When the discharge current value is equal to or less than the particular current value, the procedure goes to step S3. When the discharge current value is larger than the particular current value, the procedure goes to step S6.

If the discharge current value is equal to or lower than the particular current value, the discharge process of the power storage unit 30 does not include the under voltage period. If the discharge current value is larger than the particular current value, the discharge process of the power storage unit 30 includes the under voltage period. Thus, the discharge voltage is lower than the first predetermined voltage during the under voltage period.

In step S5, the power control unit 10 determines whether the protection voltage is equal to the first predetermined voltage. When the protection voltage is different from the first predetermined voltage, the power control unit 10 resets the protection voltage to be equal to the first predetermined voltage. When the protection voltage is equal to the first predetermined voltage, the power control unit 10 keeps the power storage unit 30 discharging.

In step S6, the processing unit 20 obtains the particular voltage corresponding to the particular parameter group of the discharge temperature and the discharge current value from the second predetermined voltages stored in the storage module 200.

In step S7, the protection voltage is set to be equal to the particular voltage. The processing unit 20 transmits a signal indicating the particular voltage to the power control unit 10. The power control unit 10 sets the protection voltage to be equal to the particular voltage. Because the particular voltage is equal to a minimum voltage when discharging the power storage unit 30 when the discharge current value is at the discharge temperature during the under voltage period, the power control unit 10 will keep the power storage unit 30 discharging during the under voltage period.

In step S8, the processing unit 20 determines whether the discharge voltage of the power storage unit 30 is lower than the particular voltage. When the discharge voltage is lower than the particular voltage, the power control unit 10 stops the power storage unit 30 discharging. When the discharge voltage is equal to or larger than the particular voltage, the procedure goes to step S3.

The processing unit 20 obtains the discharge voltage of the power storage unit 30 through the power control unit 10. When the discharge voltage of the power storage unit 30 is lower than the particular voltage, the processing unit 20 transmits a control signal to the power control unit 10 to stop the power storage unit 30 from discharging. For example, the power storage unit 30 stops discharging when the power storage unit is short circuited, this is to protect against damaging the power storage unit 30.

The above power control system and method is operated by determining whether the discharge process of the power storage unit 30 includes a transient period and an under voltage period or not. When the discharge process of the power storage unit 30 includes the transient period, the processing unit 20 determines whether the discharge process of the power storage unit 30 includes the under voltage period. When the discharge process of the power storage unit 30 includes the under voltage period, the protection voltage of the power storage unit 30 can be changed according to the discharge temperature and the discharge current value of the power storage unit 30. Thus, the protection voltage of the power storage unit 30 can be adjusted during the unstable beginning of the discharge process, and the stability of the electronic device 40, such as a server, can be increased.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power control system for controlling power to an electronic device, comprising:
a power storage unit configured to discharge power to the electronic device;
a power control unit configured to obtain a discharge voltage, a discharge current value and a discharge temperature of the power storage unit, and to stop the power storage unit discharging when the discharge voltage is smaller than a protection voltage; and
a processing unit comprising a storage module storing a predetermined temperature and a plurality of predetermined current values, wherein the discharge temperature corresponds to one of the plurality of predetermined current values, and the protection voltage is changed when the discharge temperature is lower than the predetermined temperature and the discharge current value is larger than the one of the plurality of predetermined current values.

2. The power control system of claim 1, wherein the power storage unit has a transient period when the discharge temperature is lower than the predetermined temperature.

3. The power control system of claim 2, wherein the discharge voltage decreases to a minimum voltage and then increases to a stable voltage during the transient period.

4. The power control system of claim 3, wherein the power storage unit starts to discharge at a first time, the discharge voltage reaches the stable voltage from the minimum voltage at a second time, and the transient period is a time interval between the first time and the second time.

5. The power control system of claim 2, wherein the protection voltage is changed from a first predetermined voltage before the discharge voltage decreases to be smaller than the first predetermined voltage during the transient period, and the protection voltage is changed back to the first predetermined voltage after the discharge voltage increases to be larger than the first predetermined voltage.

6. The power control system of claim 1, wherein the storage module stores a plurality of second predetermined voltages, and a parameter group of the discharge temperature and the discharge current value corresponds to one of the plurality of second predetermined voltages.

7. The power control system of claim 6, wherein the protection voltage is changed to be equal to the one of the plurality of second predetermined voltages when the discharge temperature is lower than the predetermined temperature and the discharge current value is larger than the one of the plurality of predetermined current values.

8. The power control system of claim 1, wherein the processing unit determines whether the discharge temperature is lower than the predetermined temperature or not and whether the discharge current value is larger than the one of the plurality of predetermined current values or not.

9. The power control system of claim 1, wherein each of the predetermined current values corresponds to a temperature value.

10. The power control system of claim 1, wherein the power storage unit is charged by the power control unit through a power supply when the power supply is supplying power to the electronic device, and the power storage unit supplies power to the electronic device when the power supply stops supplying power to the electronic device.

11. A power control method for controlling power to an electronic device, comprising:
setting a protection voltage of a power storage unit;
discharging the power storage unit with a discharge voltage and a discharge current value at a discharge temperature, wherein the power storage unit stops discharging when the discharge voltage is smaller than the protection voltage;
determining whether the discharge temperature is lower than a predetermined temperature;
determining whether the discharge current value is larger than a particular current value when the discharge temperature is lower than the predetermined temperature, wherein the particular current value is selected from a plurality of predetermined current values according to the discharge temperature; and
changing the protection voltage when the discharge current value is larger than the particular current value.

12. The power control method of claim 11, wherein each of the plurality of predetermined current values corresponds to a temperature value.

13. The power control method of claim 11, wherein the power storage unit has a transient period when the discharge temperature is lower than the predetermined temperature, and the discharge voltage decreases to a minimum voltage and then increases to a stable voltage during the transient period.

14. The power control method of claim 11, wherein the protection voltage is changed to be equal to a particular voltage when the discharge temperature is lower than the predetermined temperature and the discharge current value is larger than the particular current value.

15. The power control method of claim 14, wherein the particular voltage is selected from a plurality of predetermined voltages according to the discharge temperature and the discharge current value.
